(19) United States
(12) Patent Application Publication
(10) Pub. No.: US 2021/0086773 A1
(43) Pub. Date: Mar. 25, 2021

(54) DRIVING BEHAVIOR EVALUATION DEVICE, METHOD, AND COMPUTER-READABLE STORAGE MEDIUM

(71) Applicant: TOYOTA JIDOSHA KABUSHIKI KAISHA, Toyota-shi (JP)

(72) Inventor: Gentaro KOGANO, Toyota-shi (JP)

(73) Assignee: TOYOTA JIDOSHA KABUSHIKI KAISHA, Toyota-shi (JP)

(21) Appl. No.: 17/022,692

(22) Filed: Sep. 16, 2020

(30) Foreign Application Priority Data
Sep. 20, 2019 (JP) 2019-171951

(51) Int. Cl. B60W 30/18; G08G 1/052; B60W 40/09; B60W 40/105

(52) U.S. Cl. CPC B60W 30/18154; G08G 1/052; G06K 9/00845; B60W 40/105; B60W 40/09

(57) ABSTRACT

The ECU of the in-vehicle system evaluates, in a driving scene passing through a stop intersection, a driving behavior with respect to a stop line at the intersection based on an accelerator-on position, which is a last position where the accelerator changed from off to on in the vicinity of the stop line and a brake stroke amount at a position predetermined distance just in front of the stop line.

### CROSS-REFERENCE TO RELATED APPLICATION

This application is based on and claims priority under 35 USC 119 from Japanese Patent Application No. 2019-171951 tiled on Sep. 20, 2019, the disclosure of which is incorporated by reference herein.

### BACKGROUND

### Technical Field

The present disclosure relates to a driving behavior evaluation device, a driving behavior evaluation method, and a computer-readable storage medium that stores a driving behavior evaluation program.

### Related Art

Japanese Patent Application Laid-Open No. 2015-125560 (Patent Document 1) discloses a technology for detecting a vehicle traveling state of a vehicle from when the vehicle approaches the intersection to when the vehicle passes through the intersection, and determining if the driver of the vehicle is exhibiting a risky driving behavior, for example, temporarily stopping, based on the detected traveling state.

According to an experiment performed by the inventor of the present application (details will be described later), it has been found that there is a new driving characteristic parameter that can accurately evaluate a driving behavior of a vehicle passing through a stop intersection. The technique described in Patent Document 1 does not consider the driving characteristic parameter when evaluating driving behavior. Therefore, there is room for improvement in the evaluation accuracy of the driving behavior passing through the stop intersection.

### SUMMARY

The present disclosure has been made in consideration of the above fact, and includes a driving behavior evaluation device, a driving behavior evaluation method, and a computer-readable storage medium storing a driving behavior evaluation program that can improve the evaluation accuracy of the driving behavior passing through a stop intersection.

A driving behavior evaluation device according to a first aspect includes a processor that evaluates a driving behavior with respect to a stop line at an intersection based on an accelerator-on position, which is a last position where an accelerator is changed from off to on in a vicinity of the stop line at the intersection, and a brake stroke amount at a position a predetermined distance in front of the stop line at the intersection.

In the first aspect, based on the accelerator-on position and the brake stroke amount, the evaluation of the driving behavior can be determined based on how much the distance and the vehicle speed respectively deviate from the average distance and vehicle speed values when approaching the intersection provided with the stop line. As a result, it is possible to improve the evaluation accuracy of the driving behavior passing through the stop intersection.

The second aspect is the driving behavior evaluation device according to the first aspect, wherein the processor evaluates the driving behavior in consideration of at least one of an average vehicle speed, a minimum vehicle speed, and a maximum vehicle speed when entering the intersection beyond the stop line.

In the second aspect, the driving behavior is evaluated based on how much at least one of the average vehicle speed, the minimum vehicle speed, and the maximum vehicle speed deviates from the respective average speed value when entering the intersection beyond the stop line. Thereby, the evaluation accuracy of the driving behavior passing through the stop intersection can be further improved.

The third aspect is the driving behavior evaluation device according to the second aspect, wherein the processor evaluates the driving behavior in consideration of a safety confirmation time, which is a time required from a stop position or a lowest vehicle speed position to a last stop position in the vicinity of the stop line.

In the third aspect, how much the safety confirmation time deviates from the average value can be reflected in the evaluation of the driving behavior. Thereby, the evaluation accuracy of the driving behavior passing through the stop intersection can be further improved.

A driving behavior evaluation method according to a fourth aspect includes, by a processor, evaluating a driving behavior with respect to a stop line at an intersection based on an accelerator-on position, which is a last position where an accelerator is changed from off to on in a vicinity of the stop line at the intersection, and the brake stroke amount at a position a predetermined distance in front of the stop line at the intersection,

According to the fourth aspect, similarly to the first aspect, it is possible to improve the evaluation accuracy of the driving behavior passing through the stop intersection.

A non-transitory computer-readable storage medium according to a fifth aspect stores a driving behavior evaluation program for executing a process that includes evaluating a driving behavior with respect to a stop line at an intersection based on an accelerator on position, which is a last position where an accelerator is changed from off to on in a vicinity of the stop line at the intersection, and a brake stroke amount at a position a predetermined distance in front of the stop line at the intersection.

According to the fifth aspect, similarly to the first aspect, it is possible to improve the evaluation accuracy of the driving behavior passing through the stop intersection.

The present disclosure has an effect that it is possible to improve the evaluation accuracy of the driving behavior passing through a stop intersection.

### BRIEF DESCRIPTION OF DRAWINGS

FIG. 1 is a block diagram illustrating a schematic configuration of a driving behavior evaluation system according to an embodiment.

FIG. 2 is a functional block diagram of an ECU of the vehicle-mounted system.

FIG. 3 is an image diagram showing six types of driving characteristic parameters extracted by a parameter extracting unit.

FIG. 4 is a table showing definitions of terms shown in FIG. 3;

FIG. 5 is a table showing an example of a scene determination table.

FIG. 6 is a flowchart illustrating an example of a driving behavior evaluation process.

FIG. 7 is a diagram showing driving characteristic parameters (in parts) collected in an experiment conducted by the inventor of the present application.

FIG. 8 is a diagram showing driving characteristic parameters (in parts) collected in an experiment conducted by the inventor of the present application.

FIG. 9 is a diagram in which, in an experiment conducted by the inventor of the present application, driving characteristic parameters relating to a position are averaged and plotted for an elderly driver and a middle-aged driver.

FIG. 10 is a diagram showing, in an experiment conducted by the inventor of the present application, driving characteristic parameters relating to vehicle speed are averaged and plotted for the elderly driver and the elderly driver.

FIG. 11 is a diagram showing, in an experiment conducted by the inventor of the present application, “safety confirmation time” on average for each of an elderly driver and a middle-aged driver.

FIG. 12 is a diagram showing, in an experiment performed by the inventor of the present application, “a brake stroke amount at a position Xm in front of a stop line” on average for each of an elderly driver and a middle-aged driver.

FIG. 13 shows a determination coefficient R² in an experiment performed by the inventor of the present application in which the driving characteristic parameters P1 to P6 are selected to maximize the determination coefficient R².

FIG. 14 shows a table showing P values and the like in an experiment performed by the inventor of the present application, in which the driving characteristic parameters P1 to P6 are selected so as to maximize a determination coefficient R².

### DETAILED DESCRIPTION

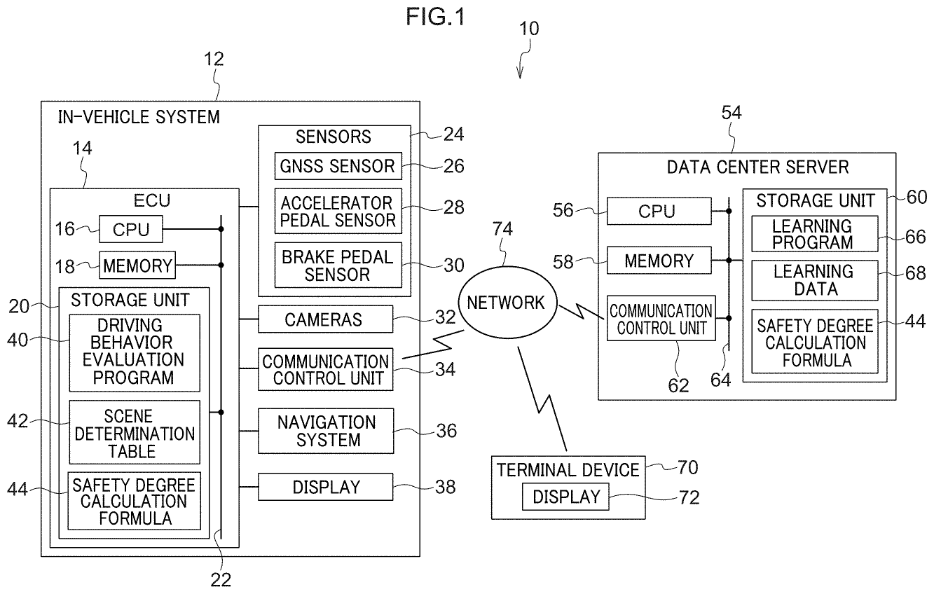

Hereinafter, an example of an embodiment of the present disclosure will be described in detail with reference to the drawings. As illustrated in FIG. 1, the driving behavior evaluation system 10 according to the embodiment includes an in-vehicle system 12 mounted on a vehicle, a data center server 54 (hereinafter, simply referred to as a server 54), and a terminal device 70. The in-vehicle system 12, the server 54, and the terminal device 70 can communicate with each other via the network 74. FIG. 1 shows only one in-vehicle system 12. However, the in-vehicle system 12 is mounted on each of several vehicles. The terminal device 70 includes, for example, a smartphone and includes the display unit 72, and is carried by a family member or the like of a driver who drives a vehicle on which the in-vehicle system 12 is mounted.

The in-vehicle system 12 includes an ECU (Electronic Control Unit) 14. The ECU 14 includes a CPU (Central Processing Unit) 16, a memory 18 such as a ROM (Read Only Memory) and a RAM (Random Access Memory), and a non-volatile storage unit 20 such as an HDD (Hard Disk Drive) and an SSD (Solid State Drive). The CPU 16, the memory 18, and the storage unit 20 are communicably connected to each other via an internal bus 22.

The ECU 14 is connected to the sensor group 24, a camera 32 for photographing the periphery of the vehicle, a communication control unit 34 for controlling communication between the vehicle-mounted system 12 and the server 54, a navigation system 36, and a display unit 38 for displaying desired information.

The sensor group 24 includes several types of sensors. The several of types of sensors include a GNSS sensor 26 that receives a positioning signal from a GNSS (Global Navigation Satellite System) satellite and acquires GNSS positioning information, an accelerator pedal sensor 28 that detects an amount of depression of an accelerator pedal, and a brake pedal sensor 30 for detecting the amount of depression of a brake pedal. The sensors other than the GNSS sensor 26, the accelerator pedal sensor 28, and the brake pedal sensor 30 included in the sensor group 24 include a vehicle speed sensor that detects the speed of the vehicle, an acceleration sensor that detects the acceleration of the vehicle, and a steering angle sensor that detects the steering angle of the vehicle. Each sensor of the sensor group 24 detects various physical quantities at predetermined time intervals while the ignition switch of the vehicle is on.

The navigation system 36 includes a storage unit (not shown) for storing map information. The navigation system 36 displays the position of the vehicle on the map displayed on the display unit 38 based on the GNSS positioning information output from the GNSS sensor 26 and the map information stored in the storage unit. Further, the navigation system 36 performs the process of guiding the vehicle along the route to the destination.

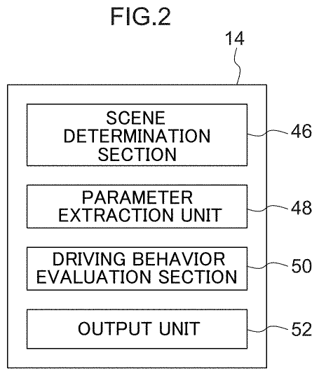

The storage unit 20 of the ECU 14 stores a driving behavior evaluation program 40, a scene determination table 42, and a safety degree calculation formula 44. In the ECU 14, the driving behavior evaluation program 40 is read from the storage unit 20 and is loaded onto the memory 18, and once loaded, the driving behavior evaluation program 40 is executed by the CPU 16. Accordingly, the ECU 14 functions as the scene determination section 46, the parameter extraction unit 48, the driving behavior evaluation section 50, and the output unit 52 illustrated in FIG. 2. Thereby, the ECU 14 functions as an example of the driving behavior evaluation device. Note that the driving behavior evaluation section 50 is an example of an evaluation unit.

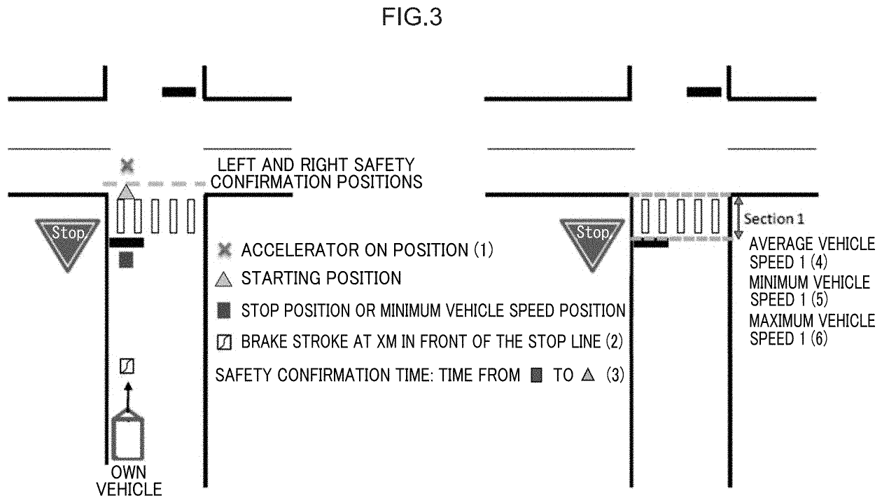

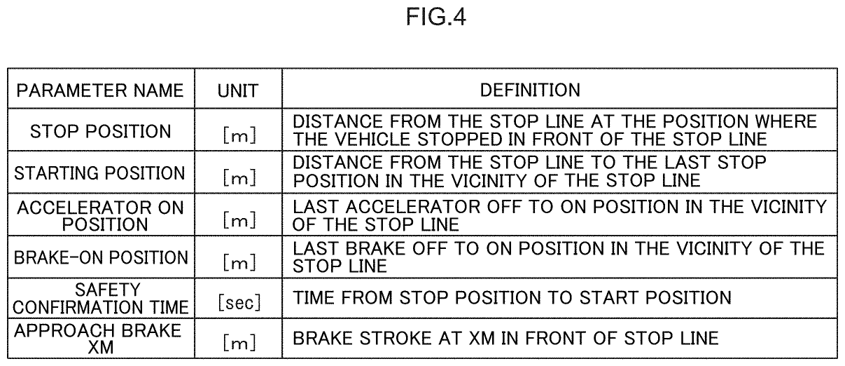

The scene determination section 46 determines a driving scene based on information stored in a scene determination table 42 described later. When the driving scene determined by the scene determination section 46 is a stop intersection passing scene, the parameter extraction unit 48 uses the sensor data detected by each sensor of the sensor group 24 to extract six types of driving characteristic parameters as shown in (1) to (6) in FIG. 3. That is, the six types of driving characteristic parameters are (1) the “accelerator on position,” which is the last position at which the accelerator changed from off to on in the vicinity of the stop line, and (2) “brake stroke amount at Xm in front of the stop line,” which is the brake stroke amount at a position Xm in front of the stop line, (3) “safety confirmation time,” which is the time required from the stop position or the lowest vehicle speed position to the last position at which the vehicle stopped in the vicinity of the stop line, (4) “average vehicle speed 1,” which is the average vehicle speed in the section (section 1) from crossing the stop line to entering the intersection, (5) “minimum vehicle speed 1,” which is the minimum vehicle speed in section 1, and (6) “maximum vehicle speed 1,” which is the maximum vehicle speed in section 1. FIG. 4 shows the definitions of the terms described in FIG. 3.

When the driving scene determined by the scene determining unit 46 is a stop intersection passing scene, the driving behavior evaluation section 50 substitutes the six types of driving characteristic parameters extracted by the parameter extracting unit 48, namely, the “accelerator on position,” the “brake stroke amount Xm in front of the stop line,” the “safety confirmation time,” the “average vehicle speed 1,” the “minimum vehicle speed 1,” and the “maximum vehicle speed 1.” Thereby, the degree of safety of the driving action in the stop intersection passing scene is calculated. An example of the safety degree calculation expression or formula 44 is shown in the following equation (1).

(Degree of safety)=a1x1+a2x2+a3x3+a4x4+a5x5+a6x6+a0 (1)

Note that, in equation (1), x1 is the “accelerator on position,” x2 is the “brake stroke amount at Xm in front of the stop line,” x3 is the “safety confirmation time,” x4 is the “average vehicle speed 1,” x5 is the “minimum vehicle speed 1” and x6 is the “maximum vehicle speed 1.” The coefficients a1, a2, a3, a4, a5, a6 and the constant a0 in the equation (1) are calculated by a learning process (described later) by the server 54.

Further, in the present embodiment, several evaluation logics for evaluating the driving behavior are prepared for each of several driving scenes other than the stop intersection passing scene. The driving behavior evaluation section 50 executes an evaluation logic corresponding to the driving scene determined by the scene determination unit 46 when the driving scene determined by the scene determination section 46 is other than the stop intersection passing scene. Thus, the driving behavior is evaluated according to the driving scene.

Specifically, the server 54 generates in advance several learned models in which the time series data of the sensor data is input and the time series data of the same number of sensor data as the input is output. The several learned models are generated for each driving scene by performing machine learning using sensor data acquired when driving with relatively high evaluation of driving behavior is performed as training data. Thereby, the several learned models are associated with each of the several driving scenes. More specifically, the server 54 makes the model learn in a way that the time series data of the output sensor data when the time series data of the sensor data is input becomes equal to the time series data of the input sensor data. Thereby, a learned model is generated in advance. Driving with a relatively high evaluation of driving behavior here means, for example, driving that satisfies traffic regulations and does not hinder traffic flow. As a learned model, for example, an LSTM (Long Short-Term Memory) auto encoder is applied.

The learned model for each driving scene generated by the server 54 is distributed from the server 54 to the in-vehicle system 12, and stored in the storage unit 20 of the ECU 14. When the driving scene determined by the scene determining unit 46 is other than the stop intersection passing scene, the driving behavior evaluation unit 50 inputs the time series of the sensor data to the learned model corresponding to the driving scene determined by the scene determining unit 46 and performs arithmetic processing. Then, the driving behavior evaluation section 50 derives a difference between the time-series data of the sensor data output from the learned model and the time-series data of the sensor data input to the learned model as an evaluation of the driving behavior. The difference between the input and the output of the learned model increases as the driving behavior is farther from the driving behavior having a high evaluation, that is, as the evaluation of the driving behavior decreases. As this difference, for example, a Mahalanobis distance can be applied.

The output unit 52 outputs the evaluation result of the driving behavior obtained by the driving behavior evaluation section 50. Specifically, the output unit 52 notifies the driver by outputting the evaluation result of the driving behavior to the display unit 38. For example, the output unit 52 may output a message prompting safe driving to the display unit 38 when the evaluation result of the driving behavior does not satisfy a predetermined criterion. The output unit 52 may notify the driver of the driving behavior by outputting the evaluation result of the driving behavior by a voice output device such as a speaker mounted on the vehicle.

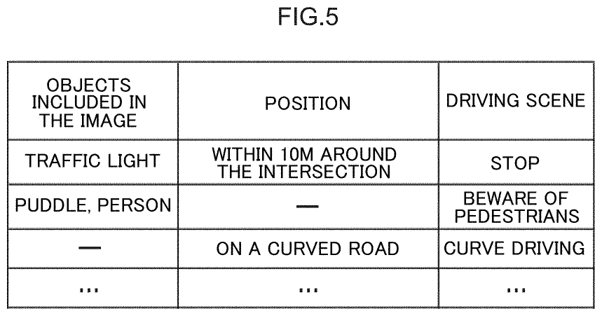

As shown in FIG. 5, the scene determination table 42 stores a driving scene in association with at least one of an object included in an image captured by the camera 32 and a vehicle position. For example, a driving scene of “passing through a stop intersection” is associated with a combination in which an object included in an image captured by the camera 32 is a traffic light and the position of the vehicle is within 10 m around the intersection. In addition, for example, when the objects included in the image captured by the camera 32 are a puddle and a person, a driving scene of “watch out for pedestrians” is associated. In addition, for example, when the vehicle is located on a curved road, a driving scene of “running along a curve” is associated. Note that several driving scenes may be associated with one combination of the object and the position of the vehicle included in the image captured by the camera 32.

The server 54 shown in FIG. 1 includes a CPU 56, a memory 58, a non-volatile storage unit 60, and a communication control unit 62 that manages communication between the server 54 and the vehicle-mounted system 12. The CPU 56, the memory 58, the storage unit 60, and the communication control unit 62 are communicably connected to each other via an internal bus 64. The storage unit 60 stores a learning program 66 and learning data 68.

The learning data 68 includes a result of a cognitive test performed on a driver of the vehicle and six types of driving characteristic parameters (the “accelerator on position,” the “brake stroke amount Xm in front of the stop line,” the “safety confirmation time,” the “average vehicle speed 1,” the “minimum vehicle speed 1,” and the “maximum vehicle speed 1”) obtained when the driver performs a driving operation passing through a stop intersection, collected for several drivers.

The server 54 executes a learning program 66 to execute a learning process of generating the safety degree calculation formula 44 from the learning data 68. For example, when the safety degree calculation expression 44 is the expression (1), the learning process performs a multiple regression analysis using the result of the cognitive test as an objective variable and the above-described six driving characteristic parameters as explanatory variables, and obtains coefficients a1, a2, a3, a4, a5, a6 and a constant a0. The safety degree calculation formula 44 generated by the learning process is temporarily stored in the storage unit 60, then delivered from the server 54 to the vehicle-mounted system 12, and stored in the storage unit 20 of the ECU 14.

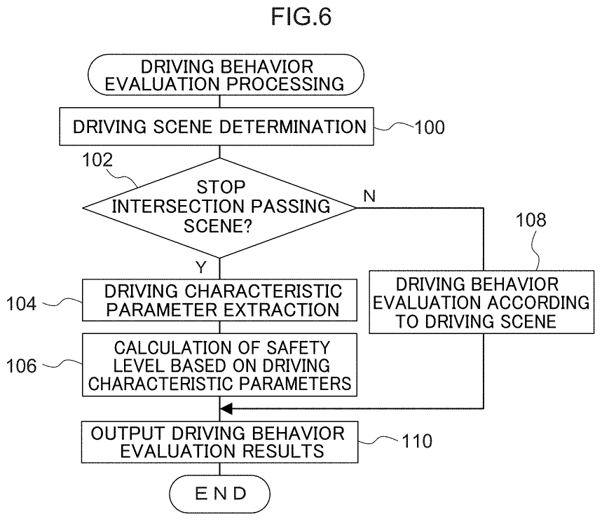

Next, as an operation of the present embodiment, a driving behavior evaluation process executed by the ECU 14 of the vehicle-mounted system 12 will be described with reference to FIG. 6.

In step 100 of the driving action determination process, the scene determination unit 46 determines the driving scene using at least one of the image represented by the image data captured by the camera 32 and the position information of the vehicle detected by the GNSS sensor 26. Specifically, the scene determination unit 46 performs a known object detection process on the image data captured by the camera 32. Thereby, an object included in the image represented by the image data is detected. Examples of the object detection processing include a Faster Region R-CNN (Regions with Convolutional Neural Networks), a YOLO (You Only Look Once), and an SSD (Single Shot Multibox Detector).

Further, the scene determination unit 46 determines what type of road position is the position represented by the position information detected by the GNSS sensor 26. In this determination, for example, the map information includes information on the road such as an intersection and a curve corresponding to the position information. Therefore, this determination can be made using the position of the vehicle and the map information.

Then, the scene determination unit 46 refers to the scene determination table 42 and determines a driving scene corresponding to the combination of the specified object and the position, a driving scene corresponding to only the specified object, and a driving scene corresponding to only the specified position, as vehicle driving scenes. The scene determining unit 46 receives the image represented by the image data and the position information of the vehicle as inputs, and may use the trained model obtained in advance by machine learning using the training data as an output of the driving scene to generate a driving scene of the vehicle.

In step 102, the parameter extracting unit 48 determines whether the driving scene determined by the scene determining unit 46 is a stop intersection passing scene. If the determination in step 102 is affirmative, the process proceeds to step 104. In step 104, the parameter extracting unit 48 extracts the above-described six types of driving characteristic parameters from the sensor data.

In the next step 106, the driving behavior evaluation section 50 substitutes the six types of driving characteristic parameters extracted by the parameter extraction unit 48 into the safety degree calculation formula 44 (for example, the above formula (1)) to perform a calculation process. Thus, the degree of safety of the driving action (evaluation value of the driving action) in the stop intersection passing scene is calculated.

On the other hand, when the driving scene determined by the scene determining unit 46 is not the scene passing through the stop intersection in step 102, the process proceeds to step 108. In step 108, the driving behavior evaluation section 50 executes the evaluation logic corresponding to the driving scene determined by the scene determination unit 46 from among the several evaluation logics prepared for each of the several driving scenes, thereby evaluating the corresponding driving behavior.

After performing the process of step 106 or step 108, the process proceeds to step 110. In step 110, the output unit 52 displays the evaluation result of the driving behavior obtained in step 106 or step 108 on the display unit 38, thereby notifying the driver. When the processing in step 110 ends, the driving behavior evaluation processing ends.

The output unit 52 may transmit the evaluation result of the driving behavior by the driving behavior evaluation unit 50 to the server 54 via the network 74. In this case, the server 54 accumulates the evaluation of the driving behavior periodically transmitted from each vehicle. Further, in this case, the server 54 compiles the evaluations accumulated for each vehicle at a regular timing such as once a month, for example. Then, the counting result is notified to the vehicle owner or the terminal device 70 by e-mail or the like. The evaluation of the driving behavior of each vehicle may be used, for example, for calculating an insurance premium.

As described above, in the present embodiment, in the driving scene passing through the stop intersection, the driving behavior with respect to the stop line at the intersection is evaluated based on the accelerator-on position, which is the position where the accelerator last changed from off to on in the vicinity of the stop line of the intersection, and the brake stroke amount at a position that is a predetermined distance in front of the stop line of the intersection. Thereby, based on the accelerator-on position and the brake stroke amount, it is possible to determine the evaluation of the driving behavior based on how much the distance and the vehicle speed when approaching the intersection with the stop line deviate from the average value. Therefore, the evaluation accuracy of the driving behavior passing through the stop intersection can be improved.

Further, in the present embodiment, in the driving scene passing through the stop intersection, the driving action is performed in consideration of at least one of the average vehicle speed, the minimum vehicle speed, and the maximum vehicle speed when entering the intersection beyond the stop line. As a result, it is possible to determine the evaluation of the driving behavior based on how much at least one of the average vehicle speed, the minimum vehicle speed, and the maximum vehicle speed when approaching the intersection beyond the stop line deviates from the average value. Therefore, it is possible to further improve the evaluation accuracy of the driving behavior passing through the stop intersection.

Further, in the present embodiment, in a driving scene passing through a stop intersection, the driving action is performed in consideration of a safety confirmation time which is a time from a stop position or a lowest vehicle speed position to a last position in the vicinity of the stop line where the vehicle stopped. Thus, how much the safety confirmation time deviates from the average value can be reflected in the evaluation of the driving behavior. Therefore, it is possible to further improve the evaluation accuracy of the driving behavior passing through the stop intersection.

In the above description, in the driving scene passing through the stop intersection, the mode in which the driving behavior is evaluated using all the six types of driving characteristic parameters has been described, but the present invention is not limited to this. For example, the driving behavior may be evaluated using only the “accelerator-on position” and the “brake stroke amount at Xm in front of the stop line,” or in addition to this, the driving behavior may be evaluated in consideration of at least one of “safety confirmation time,” “average vehicle speed 1,” “minimum vehicle speed 1,” and “maximum vehicle speed 1.”

In the above description, the mode in which the driving behavior is evaluated based on the driving behavior when the vehicle has passed the intersection once has been described. However, the present invention is not limited to this, and the driving behavior may be evaluated based on the frequency determined as dangerous driving in each driving behavior when the vehicle passes through the intersection several times.

In the above, the mode in which the in-vehicle system 12 executes the driving behavior evaluation process (FIG. 6) has been described. However, the present invention is not limited to this, and the process may be executed by the server 54. In this case, the server 54 functions as a driving behavior evaluation device.

Further, in the above description, the mode in which the driving behavior is evaluated in real time for the driving scene passing through the stop intersection has been described, but the present invention is not limited to this. For example, the sensor data or the driving characteristic parameters are accumulated for a predetermined period (for example, one month), the driving behavior is evaluated offline by the server 54 or the like based on the accumulated data, the evaluation result of the driving behavior is obtained and distributed to a driver, his family, etc. at a later time.

In the above description, the driving behavior evaluation program 40 according to the present disclosure has been described as being stored (installed) in the storage unit 20 in advance. However, it is also possible to provide the driving behavior evaluation program according to the present disclosure in a form recorded on a recording medium such as a CD-ROM, a DVD-ROM, or the like.

### EXAMPLE

Hereinafter, an experiment performed by the present inventors will be described. In this experiment, the driving simulator reproduces the situation where the vehicle travels straight through the intersection with the stop line while other vehicle passes from the side on the intersecting road. The driving operation is performed by operating the driving simulator and the driving behavior of the subject going straight across the intersection was collected for a total of 11 driving characteristic parameters.

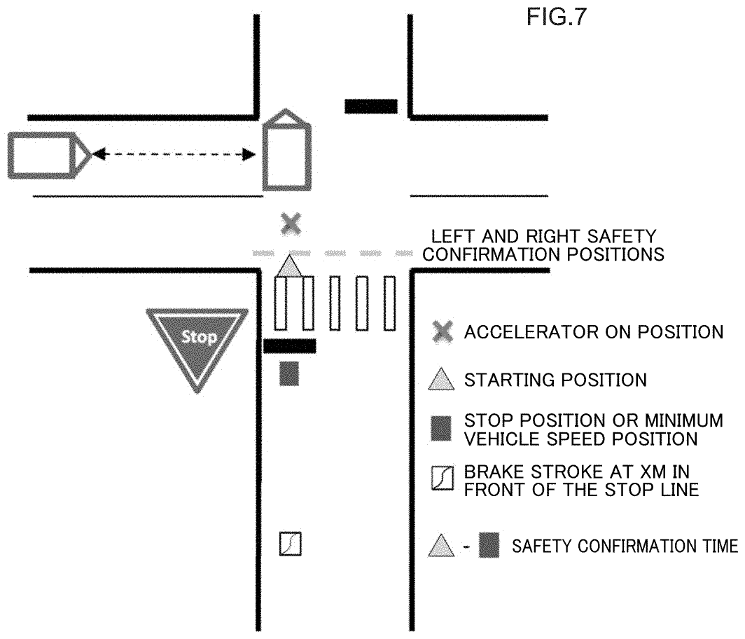

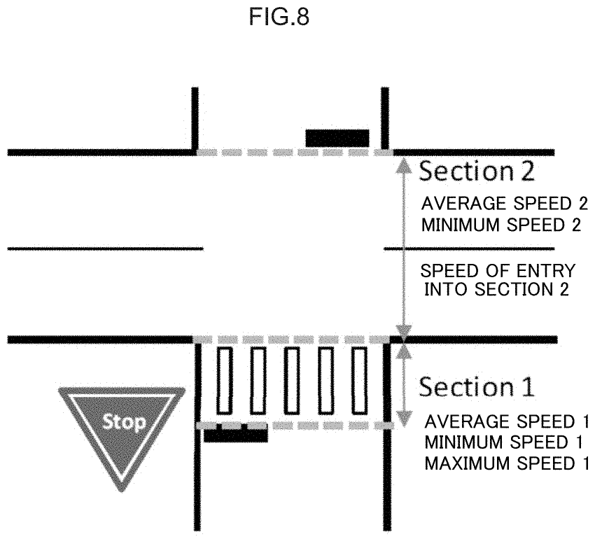

The collected driving characteristic parameters are “accelerator on position” shown in FIG. 7, “starting position” which is the distance from the stop line at the last position where the vehicle stopped in the vicinity of the stop line, “stop position or minimum vehicle speed position,” “brake stroke at Xm in front of stop line,” “safety confirmation time,” and as shown in FIG. 8 “average speed 1,”“minimum speed 1,” “maximum speed 1” “average speed 2” which is the average vehicle speed in the section (section 2) after entering the intersection, “minimum speed 2,” which is the minimum vehicle speed in section 2, and “entering speed to section 2.”

In addition, a cognitive test (TMT: Trail Making Test) was performed on each subject immediately before operating the driving simulator. The inventor of the present application analyzed and examined the collected driving characteristic parameters and the results of the cognitive test. The subjects were several elderly people (65 years old or older) and middle-aged people (40-50 years old).

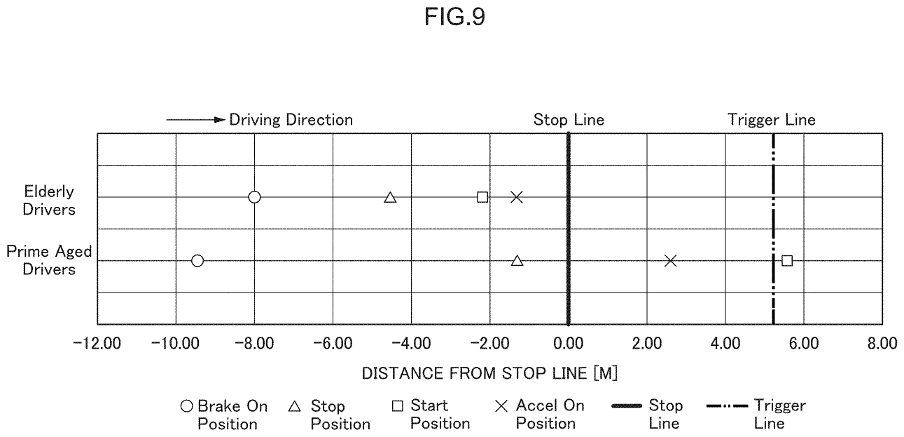

FIG. 9 is a graph obtained by averaging the driving characteristic parameters related to the position among the driving characteristic parameters collected in the experiment for elderly drivers and middle-aged drivers and plotting them. For elderly drivers, the position where the brake was last turned off to on in front of the stop line is located closer to the stop line than that for the middle-aged driver. For elderly drivers, the “stop position or minimum vehicle speed position” is located in front of the stop line, and the last release position of the brake when entering the intersection (“start position”) is clustered in the vicinity of the stop line. In addition, for the elderly driver, no clear stop is made in the vicinity of the trigger line (the position where safety can be checked on the left and right) where the vehicle from the left appears, and the “accelerator on position” is distributed in front of the stop line. The plots of “start position” and “accelerator on position” are inverted for the elderly and middle-aged drivers.

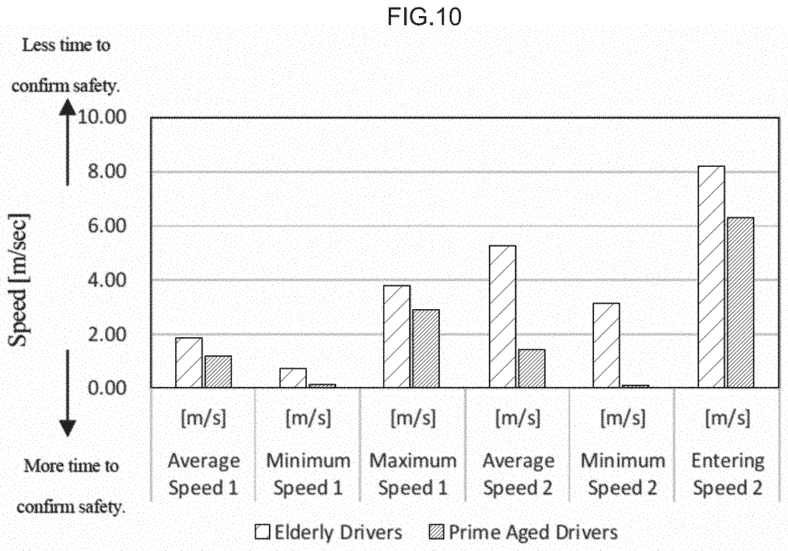

FIG. 10 shows the driving characteristic parameters related to the vehicle speed among the data collected in the experiment for the elderly drivers and the middle-aged drivers. The elderly drivers tend to be driving at a faster speed than middle-aged drivers overall. Further, it can be seen that the difference between the average vehicle speed 2 and the minimum vehicle speed 2 in the section 2 of the intersection is large.

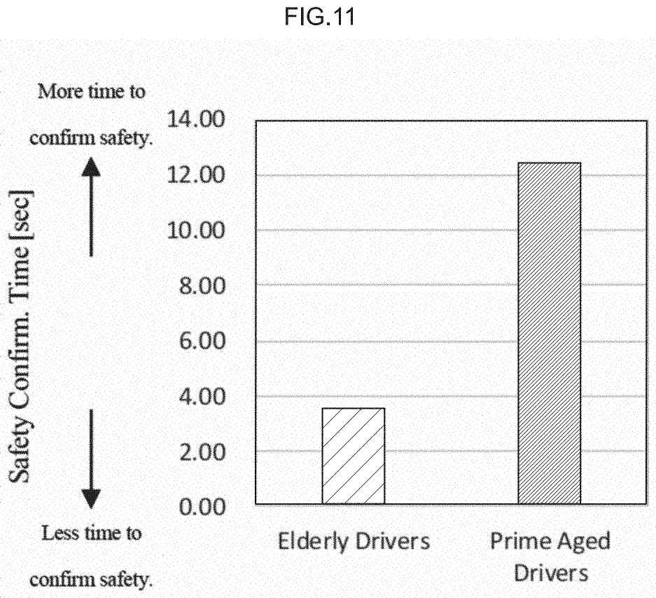

FIG. 11 shows “safety confirmation time” by taking an average as in FIG. 10. It can be seen that, for the elderly driver, the “safety confirmation time” is shorter.

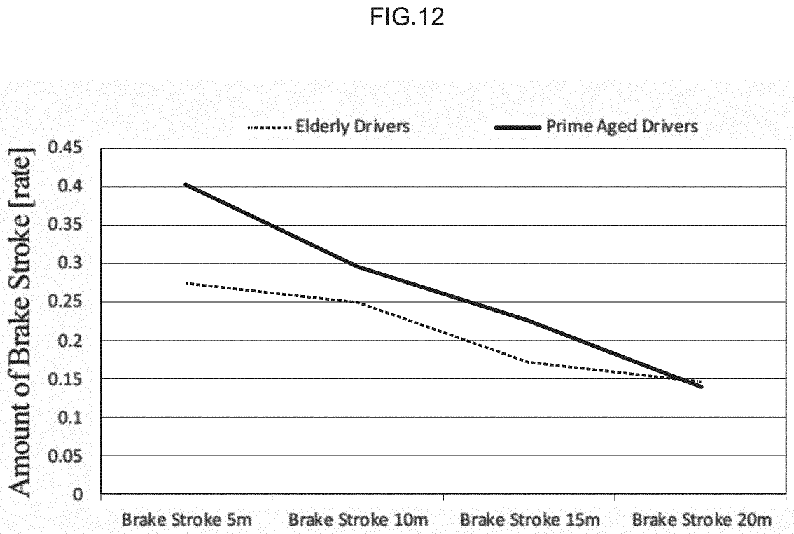

FIG. 12 shows the average brake stroke amount at the position Xm in front of the stop line for the elderly drivers and the middle-aged (Prime Aged) drivers. It can be seen that the elderly driver makes less braking in the vicinity of the intersection than the elderly driver.

The inventor of the present application has performed analysis using multivariable regression analysis in order to investigate the relationship between the collected driving characteristic parameters and the results of TMT. To this end, the result of TMT was used as an objective variable, and six driving characteristic parameters were selected from among the eleven types of driving characteristic parameters described above and used as explanatory variables. Moreover, a combination of driving characteristic parameter for which determination coefficient R² becomes largest are identified as the driving characteristic parameters P1 to P6.

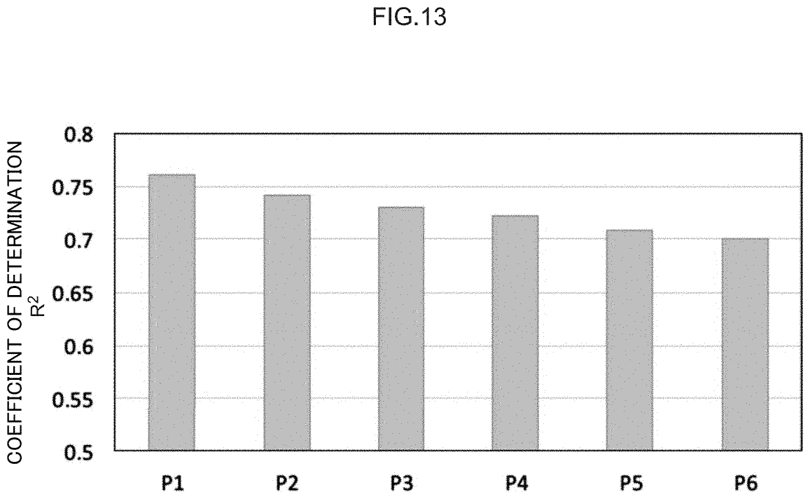

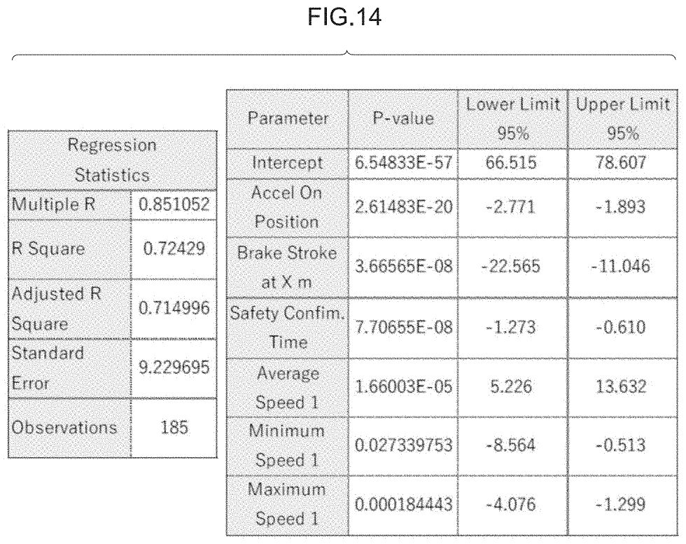

As a result, out of the eleven types of driving characteristic parameters, “accelerator-on position,” “brake stroke amount Xm in front of the stop line,” “safety confirmation time,” “average vehicle speed 1,” “maximum vehicle speed 1,” and “minimum vehicle speed 1” have been identified. The determination coefficient R² for the driving characteristic parameters P1 to P6 is shown in FIG. 13, and the P value and the like are shown in FIG. 14. As shown in FIG. 14, the driving characteristic parameters P1 to P6 have sufficiently small P values. In particular, it can be seen that the “accelerator-on position” has a small P value and has a large correlation with the TMT result among the driving characteristic parameters P1 to P6.

The “accelerator on position” shown in FIG. 9 is located in front of the stop line for the elderly driver, and is located beyond the stop line for the middle-aged or Prime Aged driver. In FIG. 10, the elderly driver exceeds the middle-aged driver in all of “average vehicle speed 1,” “minimum vehicle speed 1,” and “maximum vehicle speed 1.” This is related to the fact that the length of the safety confirmation time shown in FIG. 11 is shorter for the elderly driver, and it can be seen that the time required for the safety confirmation (cognition) is shorter for the elderly driver.

Regarding the “amount of brake stroke at Xm in front of the stop line” shown in FIG. 12 (average value), the difference between the elderly driver and the middle-aged driver is not so large. However, it is presumed that this value reflects how far the driver has started adjusting the brake stroke amount based on the distance and the vehicle speed felt by the driver when approaching the intersection. The “accelerator-on position” and the “brake stroke amount Xm in front of the stop line” are both considered to reflect the time used by the driver for recognition when passing through the stop intersection.

The following findings were obtained from the above experimental results.

(1) There are significant differences between the “accelerator-on position” and the “brake stroke amount Xm in front of the stop line” between the elderly driver and the middle-aged driver. Regression analysis has identified that the differences could be explained by cognitive differences. This suggests that the elderly driver may have a reduced sense of distance and vehicle speed when approaching the stop intersection, which is consistent with the result of TMT.

(2) “Average vehicle speed 1,” “minimum vehicle speed 1,” and “maximum vehicle speed 1” when crossing a stop line and entering an intersection are faster for the elderly driver.

What is claimed is:

1. A driving behavior evaluation device comprising a processor that evaluates a driving behavior with respect to a stop line at an intersection based on an accelerator-on position, which is a last position where an accelerator is changed from off to on in a vicinity of the stop line at the intersection, and a brake stroke amount at a position a predetermined distance in front of the stop line at the intersection.

2. The driving behavior evaluation device according to claim 1, wherein the processor evaluates the driving behavior in consideration of at least one of an average vehicle speed, a minimum vehicle speed, and a maximum vehicle speed when entering the intersection beyond the stop line.

3. The driving behavior evaluation device according to claim 1, wherein the processor evaluates the driving behavior in consideration of a safety confirmation time, which is a time required from a stop position or a lowest vehicle speed position to a last stop position in the vicinity of the stop line.

4. The driving behavior evaluation device according to claim 2, wherein the processor evaluates the driving behavior in consideration of a safety confirmation time, which is a time required from a stop position or a lowest vehicle speed position to a last stop position in the vicinity of the stop line.

5. A driving behavior evaluation method by a processor comprising:
evaluating a driving behavior with respect to a stop line at an intersection based on an accelerator-on position, which is a last position where an accelerator is changed from off to on in a vicinity of the stop line at the intersection, and based on a brake stroke amount at a position a predetermined distance in front of the stop line at the intersection.

6. A non-transitory computer-readable storage medium storing a driving behavior evaluation program for executing a process, the process comprising evaluating a driving behavior with respect to a stop line at an intersection based on an accelerator on position, which is a last position where an accelerator is changed from off to on in a vicinity of the stop line at the intersection, and a brake stroke amount at a position a predetermined distance in front of the stop line at the intersection.
